(19) United States
(12) Patent Application Publication
(10) Pub. No.: US 2021/0357730 A1
(43) Pub. Date: Nov. 18, 2021

(54) MULTI-SIZE CONVOLUTIONAL LAYER BACKGROUND

(71) Applicant: ALIBABA GROUP HOLDING LIMITED, George Town (KY)

(72) Inventors: Liang HAN, San Mateo, CA (US); Chao CHENG, San Mateo, CA (US); Yang JIAO, San Mateo, CA (US)

(21) Appl. No.: 16/872,979

(22) Filed: May 12, 2020

(51) Int. Cl. G06N 3/04; G06F 17/18; G06F 17/15

(52) U.S. Cl. CPC G06N 3/0472; G06F 17/15; G06F 17/18

(57) ABSTRACT

Systems and methods for improved convolutional layers for neural networks are disclosed. An improved convolutional layer can obtain at least two input feature maps of differing channel sizes. The improved convolutional layer can generate an output feature map for each one of the at least two input feature maps. Each input feature map can be applied to a convolutional sub-layer to generate an intermediate feature map. For each intermediate feature map, versions of the remaining intermediate feature maps can be resized to match the channel size of the intermediate feature map. For each intermediate feature map, an output feature map can be generated by combining the intermediate feature map and the corresponding resized versions of the remaining intermediate feature maps.

### BACKGROUND

Convolutional neural networks can be used for a variety of applications, including machine vision and natural language processing. Such convolutional neural networks can generate outputs by inputting feature data to convolutional layers (and optionally other types of layers) to generate output feature data. A convolutional layer can generate output feature data by convolving one or more kernels with the input feature data.

Hardware accelerators can be used when implementing neural networks, including convolutional neural networks. Such hardware accelerators offer performance benefits when used with suitable convolutional layers. Whether a convolutional layer is suitable for use with a hardware accelerator can depend on the design of the convolutional layer. The performance of a convolutional neural network can also depend on the computational and storage requirements of the convolutional layer, which can depend on the design of the convolutional layer. Accordingly, conventional convolutional neural networks may not be as suitable for hardware components.

### SUMMARY

The disclosed systems and methods relate to determination of a convolutional layer output from a convolutional layer input. The disclosed systems and methods include a system including at least one processor and at least one memory containing instructions. When executed by the at least one processor, the instructions can cause the system to perform operations. The operations can include generating a neural network output from a neural network input, generation of the neural network output. Such generation can include generating at least two output feature maps using at least two input feature maps. Generation of the at least two output feature maps can include convolving a first input feature map of the at least two input feature maps with at least one first kernel to generate a first intermediate feature map; convolving a second input feature map of the at least two input feature maps with at least one second kernel to generate a second intermediate feature map; generating, by up-sampling the first intermediate feature map, an up-sampled version of the first intermediate feature map; generating, by down-sampling the second intermediate feature map, a down-sampled version of the second intermediate feature map; combining the first intermediate feature map with the down-sampled version of the second intermediate feature map to generate a first output feature map of the at least two output feature maps; and combining the second intermediate feature map with the up-sampled version of the first intermediate feature map to generate a second output feature map of the at least two output feature maps.

The disclosed systems and methods include another system including at least one processor and at least one memory containing instructions. When executed by the at least one processor, the instructions can cause the system to perform operations. The operations can include generating a neural network output from a neural network input. Generation of the neural network output can include generating at least two output feature maps of differing channel sizes using at least two input feature maps of the differing channel sizes. Generation of the at least two output feature maps can include generating a first intermediate map by providing a first input feature map of the at least two input feature maps to a first convolutional sub-layer, the first input feature map having a first channel size; generating a second intermediate map by providing a second input feature map of the at least two input feature maps to a second convolutional sub-layer, the second input feature map having a second channel size; generating, using the first intermediate map, a version of the first intermediate map having the second channel size; generating, using the second intermediate map, a version of the second intermediate map having the first channel size; combining the first intermediate map and the version of the second intermediate map having the first channel size to generate a first output feature map of the at least two output feature maps; and combining the second intermediate map and the version of the first intermediate map having the second channel size to generate a second output feature map of the at least two output feature maps.

The disclosed systems and methods include a non-transitory computer-readable medium storing a set of instructions executable by one or more processors of a system to cause the system to perform operations. The operations can include obtaining at least two input feature maps of differing channel sizes; generating an output feature map for each one of the at least two input feature maps, generation comprising: applying the one of the at least two input feature maps to a convolutional sub-layer to generate an intermediate feature map; resizing intermediate feature maps generated from the remaining input feature maps to match the channel size of the each one of the at least two input feature maps; and combining the intermediate feature map and the resized intermediate feature maps to generate the output feature map.

The disclosed systems and methods include a method for generating output channels using a convolutional layer of a convolutional neural network. The method can include obtaining at least two input feature maps of differing channel sizes; and generating an output feature map for each one of the at least two input feature maps. Generation of an output feature map can include: applying the one of the at least two input feature maps to a convolutional sub-layer to generate an intermediate feature map; resizing intermediate feature maps generated from the remaining input feature maps to match the channel size of the each one of the at least two input feature maps; and combining the intermediate feature map and the resized intermediate feature maps to generate the output feature map.

The disclosed systems and methods include a method for generating at least two output feature maps using at least two input feature maps, using a convolutional layer of a convolutional neural network. The method can include: convolving a first input feature map of the at least two input maps with at least one first kernel to generate a first intermediate feature map; convolving a second input feature map of the at least two input maps with at least one second kernel to generate a second intermediate feature map; generating, by up-sampling the first intermediate feature map, an up-sampled version of the first intermediate feature map; generating, by down-sampling the second intermediate feature map, a down-sampled version of the second intermediate feature map; combining the first intermediate feature map with the down-sampled version of the second intermediate feature map to generate a first output feature map of the at least two output feature maps; and combining the second intermediate feature map with the up-sampled version of the first intermediate feature map to generate a second output feature map of the at least two output feature maps.

The disclosed systems and methods include a method for generating at least two output feature maps of differing channel sizes using at least two input feature maps of the differing channel sizes, using a convolutional layer of a convolutional neural network. The method can include: generating a first intermediate map by providing a first input feature map of the at least two input feature maps to a first convolutional sub-layer, the first input feature map having a first channel size; generating a second intermediate map by providing a second input feature map of the at least two input feature maps to a second convolutional sub-layer, the second input feature map having a second channel size; generating, using the first intermediate map, a version of the first intermediate map having the second channel size; generating, using the second intermediate map, a version of the second intermediate map having the first channel size; combining the first intermediate map and the version of the second intermediate map having the first channel size to generate a first output feature map of the at least two output feature maps; and combining the second intermediate map and the version of the first intermediate map having the second channel size to generate a second output feature map of the at least two output feature maps.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which comprise a part of this specification, illustrate several embodiments and, together with the description, serve to explain the principles and features of the disclosed embodiments. In the drawings:

FIG. 1 depicts the exemplary operation of an unconventional convolutional layer, in accordance with some embodiments of the present disclosure.

FIG. 2 depicts an exemplary logical diagram of a convolutional neural network configured to use the unconventional convolutional layer of FIG. 1, in accordance with some embodiments of the present disclosure.

FIG. 3 depicts an exemplary method for generating an output feature map from an input feature map including multiple groups of input channels, in accordance with some embodiments of the present disclosure.

FIG. 4 depicts the exemplary operation of a second unconventional convolutional layer, in accordance with some embodiments of the present disclosure.

FIG. 5 depicts an exemplary logical diagram of a convolutional neural network configured to use the unconventional convolutional layer of FIG. 4, in accordance with some embodiments of the present disclosure.

FIG. 6 depicts a second exemplary method for generating an output feature map from an input feature map including multiple groups of input channels, in accordance with some embodiments of the present disclosure.

FIG. 7 illustrates an exemplary parallel computing architecture suitable for implementing the convolutional layers of FIGS. 1-6, in accordance with some embodiments of the present disclosure.

FIG. 8 illustrates an exemplary hardware accelerator core architecture, in accordance with some embodiments of the present disclosure.

FIG. 9 illustrates a schematic diagram of an exemplary cloud system incorporating a neural network processing architecture, in accordance with some embodiments of the present disclosure.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

Convolutional neural networks, which can be used for applications including machine vision and natural language processing, can generate outputs by inputting feature data to convolutional layers (and optionally other types of layers) to generate output feature data. A convolutional layer can generate output feature data by convolving one or more kernels with the input feature data.

Reducing the size of the input feature data can improve the efficiency of a convolutional layer. For example, in octave convolution, as described in “Drop an Octave: Reducing Spatial Redundancy in Convolutional Neural Networks with Octave Convolution,” the input feature data includes two feature maps at different spatial frequencies. The low frequency feature map can be smaller than the high frequency feature map, potentially reducing the computational and storage requirements of octave convolution as compared to conventional convolution. Furthermore, by causing the output features to depend on both high and low spatial frequency features, octave convolution effectively enlarges the receptive field of each output feature, potentially improving the performance of convolutional neural networks including octave convolution layers. Octave convolution requires additional operations, however, as compared to regular convolution. An octave convolution layer may require two separate convolution operations to generate each output channel of a feature map. In one convolution, the low frequency feature map can be convolved with a low frequency kernel to generate a low frequency output. In another convolution, the high frequency feature map can be convolved with a high frequency kernel to generate a high frequency output. The low frequency output or high frequency output can then be up-sampled or down-sampled to match the high frequency output or low frequency output, respectively. The two outputs, now of matching sizes, can be added together to create the output channel. To create the output feature map, these operations can be repeated using a different kernel for each output channel.

The additional operations required by octave convolution can reduce computational efficiency and increased data movement requirements. These additional operations may particularly inhibit performance when using dedicated hardware accelerators with coarse operation granularity. As a result, using octave convolution layers on such accelerators may increase computational requirements and extend execution time, as compared to using traditional convolution layers. According, implementing convolution layers with reduced-size input feature maps using dedicated hardware accelerators presents a technical problem.

The disclosed embodiments address this technical problem using unconventional convolution layers. In some embodiments, such unconventional convolution layers can be configured to receive an input feature map comprising channels of differing sizes, resize the channels, and then convolve the channels to generate an output feature map. In some instances, for example, the convolutional layer can receive channels of differing sizes, create a full set of the channels for each size, convolve each full set of the channels with a corresponding kernel to generate an output layer, and combine the output layers to form the output feature map. Resizing the channels prior to convolution can reduce the number of resizing operations performed. For example, rather than resizing convolution operation outputs individually, multiple input channels can be resized together. In some embodiments, an output channel can be generated using a single convolution operation, rather than two convolutions. In various embodiments, an output channel can be created without requiring the addition of convolution outputs of differing sizes, as in octave convolution. Accordingly, the disclosed embodiments are suitable for use with dedicated convolution accelerators having coarse operation granularity. The disclosed embodiments therefore enable such architectures to realize the identified benefits of convolution layers using reduced-size input feature maps, thereby improving the computational efficiency, storage requirements, and precision of convolutional neural networks.

In various embodiments, such unconventional convolution layers can be configured to receive two input feature maps. The two input feature maps may comprise channels of differing sizes (e.g., a larger size feature map and a smaller size feature map). The input feature maps can be convolved with corresponding channels to generate intermediate feature maps of differing sizes (e.g., an intermediate feature map having the larger feature map size and an intermediate feature map having the smaller feature map size). The intermediate feature maps can be combined to generate two output feature maps of differing sizes (e.g., a first output feature map having the larger feature map size and a second output feature map having the smaller feature map size). In some instances, the generation of the two output feature maps can be performed by two separate pipelines of a hardware accelerator. In some embodiments, combining the intermediate feature maps can include resizing the intermediate features maps. In some embodiments, combining the intermediate feature maps can include concatenating the intermediate feature maps or generating the output feature map as an element-wise function of the intermediate feature maps. Resizing the channels after convolution can reduce the number of resizing operations performed. For example, rather than resizing convolution operation outputs individually, multiple output channels can be resized together. In some embodiments, an output channel can be generated using a single convolution operation, rather than two convolutions. In various embodiments, an output channel can be created without requiring the addition of convolution outputs of differing sizes, as in octave convolution. Accordingly, the disclosed embodiments are suitable for use with dedicated convolution accelerators having coarse operation granularity. The disclosed embodiments therefore enable such architectures to realize the identified benefits of convolution layers using reduced-size input feature maps, thereby improving the computational efficiency, storage requirements, and precision of convolutional neural networks.

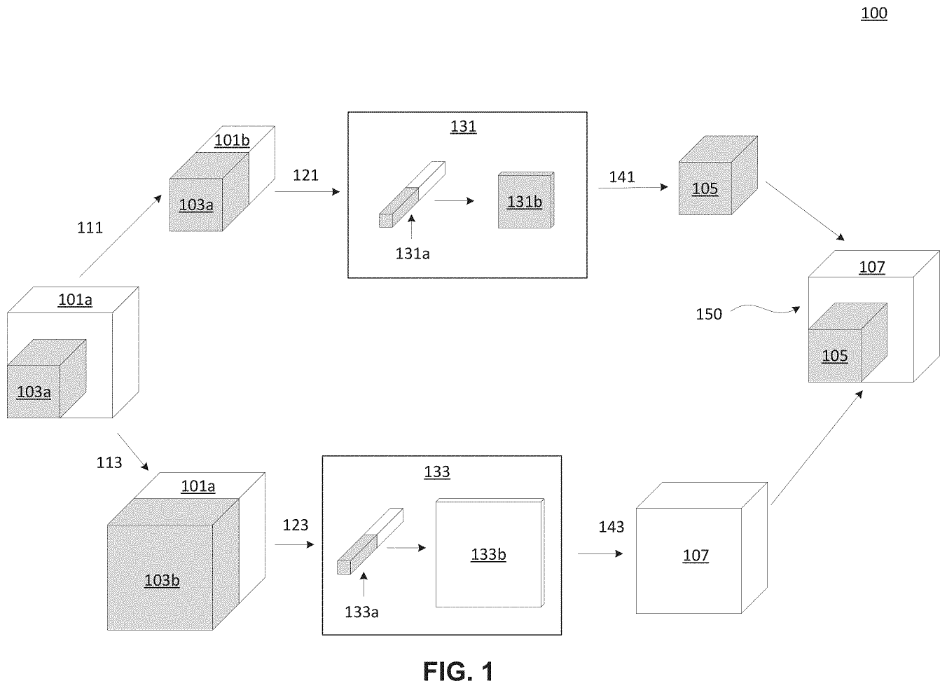

FIG. 1 depicts the exemplary operation of an unconventional convolutional layer 100, consistent with some embodiments of the present disclosure. Convolutional layer 100 can be part of a convolutional neural network configured to generate a convolutional neural network output (e.g., a label, a modified image, a caption, or the like) from a convolutional neural network input (e.g., image data, word embeddings, or the like). Generation of the neural network output can involve processing the convolutional neural network input data through successive processing layers, including convolutional layer 100. Such layers can generate output feature maps using input feature maps. In the example shown in FIG. 1, the input feature map includes a group of high-frequency input channels 101a and a group of low frequency input channels 103a. The output feature map can include a group of low-frequency output channels 105 and a group of high-frequency output channels 107. In this exemplary embodiment, by resizing the input channels prior to convolving the input channels with the kernels (e.g., kernels 131a and 133a), convolutional layer 100 can generate output channels in a single convolution and without requiring the re-sizing and addition of convolution outputs.

Convolutional layer 100 may be implemented using any of a variety of electronic systems. For example, convolutional layer 100 could be implemented using a server, one or more nodes in a datacenter, a desktop computer, a laptop computer, a tablet, a smartphone, a wearable device such as a smartwatch, an embedded device, an IoT device, a smart device, a sensor, an orbital satellite, or any other electronic device capable of computation. Additionally, the implementation of convolutional layer 100 within a given device may vary over time or between instances of convolutional layer 100. For example, in some instances convolutional layer 100 may be implemented using a general processing unit, such as a central processing unit (CPU), a graphics processing unit (GPU), or a general-purpose graphics processing unit (GPGPU). In other embodiments, the artificial neural network may be implemented using a hardware accelerator, such as a neural processing unit (NPU), a field programmable gate array (FPGA), or an application-specific integrated circuit (ASIC).

The input feature map can include groups of channels. Though depicted in FIG. 1 as including two groups of channels (e.g., input group 101a and input group 103a), the input feature map can include more than two groups of channels. For example, the input feature map can include between two and thirty-two groups of channels (e.g. 2, 4, 8, 16, or 32 groups of channels), or more than thirty-two groups of channels. Each group of channels can include one or more channels. The depth of a group of channels can be the number of channels in the group. The depth of an input feature map can be the number of channels in the input feature map.

Each input channel can have a size. The size can be the number of feature values in the input channel. For example, an input channel of size 256 can include 256 feature values. In some embodiments, the input channels can be structured as arrays having a height and a width. For example, an input channel of size 256 can have a height of 16 and a width of 16. In some embodiments, each channel in a group of channels can have the same size. Each channel in a group of channels may further have the same width and height.

As depicted in FIG. 1, in step 111 convolutional layer 100 can be configured to generate a first input feature map by resizing input group 101a to create input group 101b. As shown, input group 101b can have the same size as input group 103a. For example, input group 101b can have the same width and height as input group 103a. In some aspects, convolutional layer 100 can be configured to down-sample input group 101a to create input group 101b. Such down-sampling may be accomplished using convolution (e.g., convolving each channel in input group 101a with a kernel using a stride greater than one, or the like), pooling (max pooling, average pooling, or the like), sampling (e.g., integer or non-integer sampling, or the like), or another suitable down-sampling method. In some embodiments, input group 101b would then include a down-sampled channel corresponding to each original channel in input group 101a.

Similarly, as depicted in FIG. 1, in step 113 convolutional layer 100 can be configured to generate a second input feature map by resizing input group 103a to create input group 103b. As shown, input group 103b can have the same size as input group 101a. For example, input group 103b can have the same width and height as input group 101a. In some aspects, convolutional layer 100 can be configured to up-sample input group 103a to create input group 103b. Such up-sampling may be accomplished using deconvolution (e.g., a transposed convolution layer or the like), unpooling, interpolation (e.g., linear interpolation or the like), or another suitable up-sampling method. In some embodiments, input group 103b would then include an up-sampled channel corresponding to each original channel in input group 103a.

In step 121, convolutional layer 100 can be configured to convolve a combination of resized input group 101b and input group 103a. The combination can be a concatenation of input group 101b and input group 103a. In some embodiments, this convolution can be performed by a convolutional sub-layer 131. Convolutional sub-layer 131 can be a logical or physical sub-layer. As a non-limiting example of a logical sub-layer, convolutional layer 100 can be configured with data or instructions causing convolutional layer 100 to call a function or service that performs convolution on the combination of input group 101b and input group 103a. As a non-limiting example of a physical sub-layer, convolutional layer 100 can be implemented using a special purpose architecture configured with hardware accelerators for performing convolution. Convolutional layer 100 can be configured to provide the combination of input group 101b and input group 103a to such a hardware accelerator. Convolutional sub-layer 131 can be configured to convolve the combination of input group 101b and input group 103a by one or more kernels to generate one or more output channels. For example, as shown in FIG. 1, convolutional sub-layer 131 can be configured to convolve the combination of input group 101b and input group 103a by kernel 131a to generate output channel 131b. As shown, kernel 131a can include a portion corresponding to input group 103a and a portion corresponding to input group 101b. In some embodiments, the number of kernels can determine the number of output channels created by convolutional sub-layer 131.

Similarly, in step 123, convolutional layer 100 can be configured to convolve a combination of resized input group 103b and input group 101a. The combination can be a concatenation of input group 103b and input group 101a. In some embodiments, this convolution can be performed by a convolutional sub-layer 133 similar to convolutional sub-layer 131, described above. In some embodiments, convolutional sub-layer 133 and convolutional sub-layer 131 can be the same convolutional sub-layer (e.g., constitute two invocations of the same method, use the same hardware accelerator, or the like). Convolutional sub-layer 133 can be configured to convolve the combination of input group 101a and input group 103b by one or more kernels to generate one or more output channels. For example, as shown in FIG. 1, convolutional sub-layer 131 can be configured to convolve the combination of input group 101a and input group 103b by kernel 133a to generate output channel 133b. As shown, kernel 133a can include a portion corresponding to input group 101a and a portion corresponding to input group 103b. In some embodiments, the number of kernels can determine the number of output channels created by convolutional sub-layer 133.

In steps 141 and 143, convolutional layer 100 can be configured to combine the output channels generated by convolutional sub-layers 131 and 133 to create output channel group 105 and output channel group 107, respectively. In some embodiments, convolutional layer 100 can be configured to concatenate the output channels created by convolutional sub-layers 131 and 133 to create output channel group 105 and output channel group 107, respectively. In step 150, in various embodiments, output channel group 105 and output channel group 107 can be combined to form the output feature map. In some instances, convolutional layer 100 can be configured to create or update a data structure to store the output feature map. In some embodiments, the data structure can include output channel group 105 and output channel group 107. In various embodiments, the data structure can include references to data structures including output channel group 105 and output channel group 107, respectively. In some embodiments, the output feature map can be provided to an activation function (e.g., identity function, binary step function, logistic function, tanh function, rectified linear unit function, or other activation function) to create the input feature map for the next layer in the convolutional neural network.

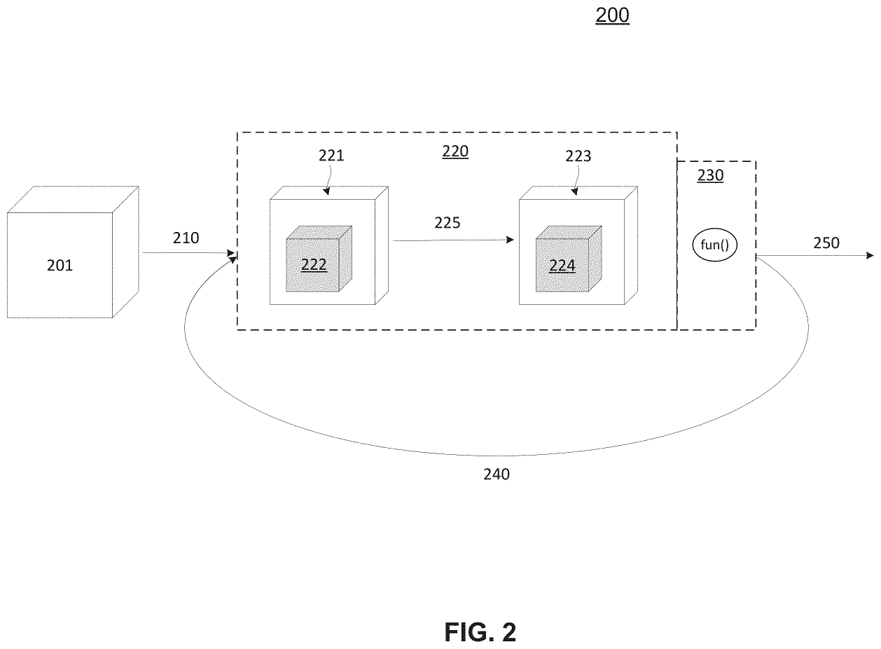

FIG. 2 depicts an exemplary logical diagram of a convolutional neural network (CNN 200) configured to use the unconventional convolutional layer described in FIG. 1. Similar to convolutional layer 100 of FIG. 1, CNN 200 may be implemented using a variety of electronic systems and the implementation of CNN 200 within a given device may vary over time or between instances of CNN 200. In some instances, the convolutional layer may be implemented using a general processing unit, such as a central processing unit (CPU), a graphics processing unit (GPU), or a general-purpose graphics processing unit (GPGPU). In other embodiments, the artificial neural network may be implemented using a hardware accelerator, such as a neural processing unit (NPU), a field programmable gate array (FPGA), or an application-specific integrated circuit (ASIC). For convenience of description and without limitation or prejudice to other implementations, CNN 200 is referred to hereafter as being implemented using a hardware accelerator. The feedback depicted in FIG. 2 can enable this hardware accelerator to be reused to implement multiple convolutional layers in the neural network.

As shown in FIG. 2, CNN 200 can be configured to receive an initial feature map 201. In step 210, CNN 200 can be configured to generate an input feature map (e.g., including input groups 221 and 222) from initial feature map 201. Initial feature map 201 can comprise feature values received from a sensor or another device (e.g., a camera of a device implementing CNN 200, or a remote camera). The feature values can be intensity values for inputs (e.g. the intensity of light impinging on a pixel in a CMOS or CCD array). For example, when CNN 200 receives sensor data from a digital camera, the initial feature map may include three channels, each corresponding to one of the red, green, and blue channels of the digital camera sensor data.

CNN 200 can be configured to generate the input feature map by providing the initial feature map to a sequence of layers. These layers can include a convolutional layer, and may include additional layers (e.g., an embeddings layer, a fully connected layer, or the like). In some embodiments, CNN 200 can be configured to generate an input feature map having multiple groups of input channels, each of the groups including channels of a different predetermined size. CNN 200 can be configured to generate input maps corresponding to each of the different predetermined sizes. When the initial feature map matches one of the predetermined sizes, CNN 200 can be configured to use the initial feature map as the input feature map corresponding to that size. For example, when there are three predetermined sizes and the initial feature map matches one of the sizes, CNN 200 can be configured to create two additional input maps from the initial feature map, each additional input map matching one of the remaining sizes, resulting in an input map matching each of the predetermined sizes. To continue this example, CNN 200 can be configured to create three additional input maps matching each of the predetermined sizes when the initial feature map does not match any of the predetermined sizes.

CNN 200 can be configured to apply the input maps to convolutional sub-layers (e.g., through repeated calls to a convolution operation, providing of the input maps to one or more hardware accelerators, or the like) to generate output maps. Each convolutional sub-layer can be configured to convolve an input map with one or more kernels to generate one or more output channels of a corresponding predetermined size. For example, the initial feature map may comprise three channels, each channel including 1024 by 1024 elements, and the input feature map may comprise three groups of channels: a first group of three channels, each channel in the first group including 2048 by 2048 elements; a second group of three channels, each channel in the second group including 1024 by 1024 elements; and a third group of three channels, each channel in the third group including 512 by 512 elements. CNN 200 can be configured to up-sample the initial feature map to generate a first input map, use the initial feature map (or a copy thereof) as the second input map, and down-sample the initial feature map to generate the third input map. The first input map can be convolved with three kernels, which may differ, to generate the three output channels of the first output group. The second input map can be convolved with three other kernels, which may also differ, to generate the three output channels of the second output group. The third input map can be convolved with three further kernels, which may also differ, to generate the three output channels of the third output group. The first group of channels, second group of channels, and third group of channels may then be combined and passed through an activation function to generate the input feature map, which can be used by the following layer in CNN 200.

Convolutional layer 220 can be configured to receive an input feature map. This input feature map can be the input feature map created in step 210 or may be the result of further processing of the input feature map created in step 210 (e.g., processing by additional layers). The input feature map can comprise multiple groups of channels. Each group of channels can have a predetermined size. For example, as depicted in FIG. 2, the input feature map can include input group 221 and input group 222. As shown, the size of input group 221 can be larger than the size of input group 222. In step 225, the unconventional method of convolution described above with regards to FIG. 1 can be applied to the input feature map to generate an output feature map. For example, input group 221 and input group 222 can be provided to a high frequency convolutional sub-layer and a low-frequency convolutional sub-layer, which may generate an output feature map including output group 223 and output group 224. As shown, the size of output group 223 can be larger than the size of output group 224.

Activation function 230 can be configured to convert feature values in the output feature map to activation values. The activation function can be, or be a function of, an identity function, binary step function, logistic function, tanh function, rectified linear unit function, or other activation function. In some embodiments, in step 240, the activation values can be used as the inputs to convolutional layer 220. In this manner, the outputs generated by convolutional layer 220 can be repeatedly input to convolutional layer 220. Accordingly, convolutional layer 220 can be configured to provide the functionality of multiple convolutional layers. In some embodiments, in step 250, convolutional layer 220 can be configured to additionally or alternatively output the activation values. The output activation values can be provided to one or more additional layers of CNN 200, or may comprise the output of CNN 200.

In general, while described with regards to a single convolutional layer, it may be appreciated that one or more additional layers may precede the convolutional layer (e.g., an embedding layer, a fully connected layer, or the like). Similarly, one or more additional layers may follow the convolutional layer (e.g. fully connected layer, or the like). Furthermore, one or more additional layers or connections (not shown in FIG. 2) may be interposed between iterations of the convolutional layer (e.g. a pooling or unpooling layer, a batch normalization layer, residual neural network (ResNet) connections, or the like).

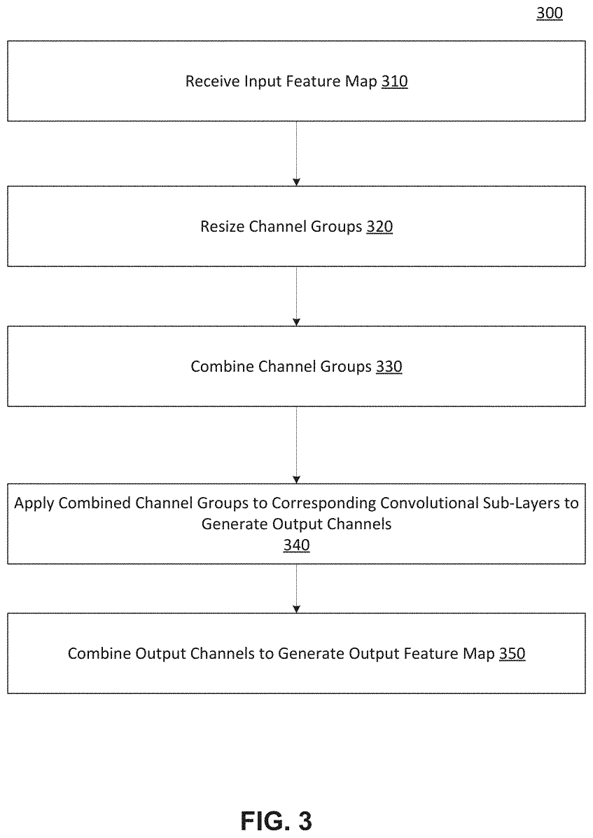

FIG. 3 depicts a method 300 for convolving an input feature map including multiple groups of input channels, in accordance with some embodiments of the present disclosure. Method 300 can include generating inputs to convolutional sub-layers by resizing and combining groups to channel inputs. Method 300 can be performed by a convolution layer. Similar to convolutional layer 100, the convolutional layer of method 300 may be implemented using any of a variety of electronic systems. Additionally, the implementation of this convolutional layer within a given device may vary over time or between instances of the convolutional layer. For example, in some instances the convolutional layer may be implemented using a general processing unit, such as a central processing unit (CPU), a graphics processing unit (GPU), or a general-purpose graphics processing unit (GPGPU). In other embodiments, the artificial neural network may be implemented using a hardware accelerator, such as a neural processing unit (NPU), a field programmable gate array (FPGA), or an application-specific integrated circuit (ASIC). Accordingly, method 300 can support reduced-size input feature maps, thereby improving the computational efficiency, storage requirements, and precision of a convolutional neural network.

In step 310 of method 300, the convolutional layer can obtain an input feature map. In some instances, the convolutional layer can receive the input feature map from another convolutional layer, or the output of the convolutional layer can be returned to the input of the convolutional layer. In various instances, the convolutional layer can generate the input feature map, for example from data received by the convolutional layer. In various instances, the convolutional layer can retrieve the input feature map from a local or remote computer memory accessible to the convolutional layer.

The input feature map can include groups of channels. Each of the groups of channels can include one or more channels. The one or more channels in a group can have the same size. For example, they can include the same number of features. As an additional example, the one or more channels in a group may have the same dimensions (e.g., the same width and height). The size of the one or more channels in each group may be predetermined. For example, these sizes may be determined prior to training of the convolutional layer. In this manner, both the number of groups, the number of channels in each group, and the predetermined size of the channels in each group may be hyperparameters associated with the convolutional layer. Such hyperparameters may be optimized during generation and training of the convolutional layer using methods such as a grid search, random search, gradient descent method, Bayesian optimization, or the like. In some embodiments, the input feature layer may include between 2 and 32 groups of channels. In various embodiments, the input feature layer may include 2, 4, 8, 16, or 32 groups of channels.

In some embodiments, the sizes for the channels in the groups may form an increasing sequence, with adjacent sizes in the sequence differing by a factor greater than one. As a non-limiting example, when there are three groups, the first group may include channels with 64 features, the second group may include channels with 256 features, and the third group may include channels with 1024 features. In this example, the adjacent sizes in the sequence differ by a factor of four. In another example, adjacent sizes in the sequence can differing by differing factor (e.g., a first group including channels with 16 features, a second group including channels with 256 features, and a third group including channels with 1024 features).

In some embodiments, a dimension for the channels in the groups may form an increasing sequence, with adjacent dimensions in the sequence differing by a factor greater than one. For example, to continue the prior non-limiting example, the first group may include channels with a width of 8, the second group may include channels with a width of 16, and the third group may include channels with a width of 32. In this example, the adjacent widths differ by a factor of two. In this example, the heights similarly differ by a factor of two. Similar to the sizes, as described above, adjacent dimensions in the sequence can differing by differing factors. Furthermore, in various embodiments, the heights and widths may differ between adjacent dimensions in the sequence by differing factors. For example, the heights may differ by a factor of two between adjacent heights in the sequence, while the widths remain unchanged.

In step 320 of method 300, the convolutional layer can resize the groups of channels in the input feature map (e.g., as described above with regards to steps 111 and 113 of FIG. 1). The convolutional layer can be configured to resize the groups of channels such that there exists, for each channel size, either the original group of channels or a resized version of the group of channels. For example, when the input feature map includes groups of channels A_{X}, B_{Y}, and C_{Z} with sizes X, Y, and Z, respectively, the convolutional layer may be configured to create resized versions A_{Y} and A_{Z} of group A_{X}, resized versions B_{X} and B_{Z} of group B_{Y}, and resized versions C_{X} and C_{Y} of group C_{Z}. In this example, following resizing, there may exist channel groups A_{X}, B_{X}, and C_{X} of size X; channel groups A_{Y}, B_{Y}, and C_{Y} of size Y; and channel groups A_{Z}, B_{Z}, and C_{Z} of size Z. In some embodiments, multiple versions of a group or versions of multiple groups may be created at the same time (e.g., all resizing may occur before any convolution). In various embodiments, a version of a group or versions of multiple groups may be created as used by the convolutional layer (e.g., B_{X} and C_{X} are created, then A_{X}, B_{X}, and C_{X} are convolved with a kernel before creation of A_{Y} or C_{Y}). The disclosed embodiments are not intended to be limited to a particular order of generating the versions of the groups. As described herein, the resizing can include at least one of convolution, max pooling, averaging pooling, deconvolution, unpooling, or interpolation.

In step 330 of method 300, the convolutional layer can combine channel groups to create inputs for convolution. For example, the convolutional layer can be configured to concatenate channel groups including channels of the same size to create an input for convolution. To continue the above example, the convolutional layer can be configured to concatenate A_{X}, B_{X}, and C_{X} to create an input D_{X} having a depth equal to the sum of the depths of A_{X}, B_{X}, and C_{X} and a height and width equal to the height and width of A_{X}, B_{X}, and C_{X}. Alternatively or additionally, the input can be generated by applying a function to A_{X}, B_{X}, and C_{X}. For example, D_{X} can be a sum, or weighted sum, of A_{X}, B_{X}, and C_{X}. In some embodiments, multiple inputs may be created at the same time (e.g., inputs D_{X}, D_{Y}, and D_{Z} may be created before any convolution). In various embodiments, an input may be created as used by the convolutional layer (e.g., input D_{X} is created and convolved to generate an output channel before creation of input D_{Y}). The disclosed embodiments are not intended to be limited to a particular order of combining the input channels.

In step 340 of method 300, the convolutional layer can apply the combined channel groups (the inputs) to convolutional sub-layers to generate output channels. As described above with regards to FIG. 1, such a convolution sub-layer can be a logical or physical sub-layer. In some embodiments, multiple inputs can be applied at the same time (e.g., all convolution may occur after all inputs are generated). In various embodiments, convolution may occur as inputs are created by the convolutional layer (e.g., input D_{X} is applied to a sub-layer to generate an output channel before creation of input D_{Y}). The disclosed embodiments are not intended to be limited to a particular order of applying the combined channel groups to the convolutional sub-layers, or a particular order of generating the output channels. As would be appreciated by one of skill in the art, the number of output channels can depend on the number of kernels convolved with each input. In some embodiments, a size of the output channels can depend on the dimensions of the inputs. The size of the output channels can also depend on parameters of the convolution (e.g., stride, padding, and the like).

In step 350 of method 300, the convolutional layer can be configured to combine the output channels to generate an output feature map. The output channels can be combined as described above with regards to FIG. 1. The disclosed embodiments are not intended to be limited to a particular method for combining the output channels to generate an output feature map. In some embodiments, following generation of the output feature map, the output feature map can be applied to an activation function, as described above with regards to FIG. 1, to generate an activation map, which can be provided to another convolutional layer.

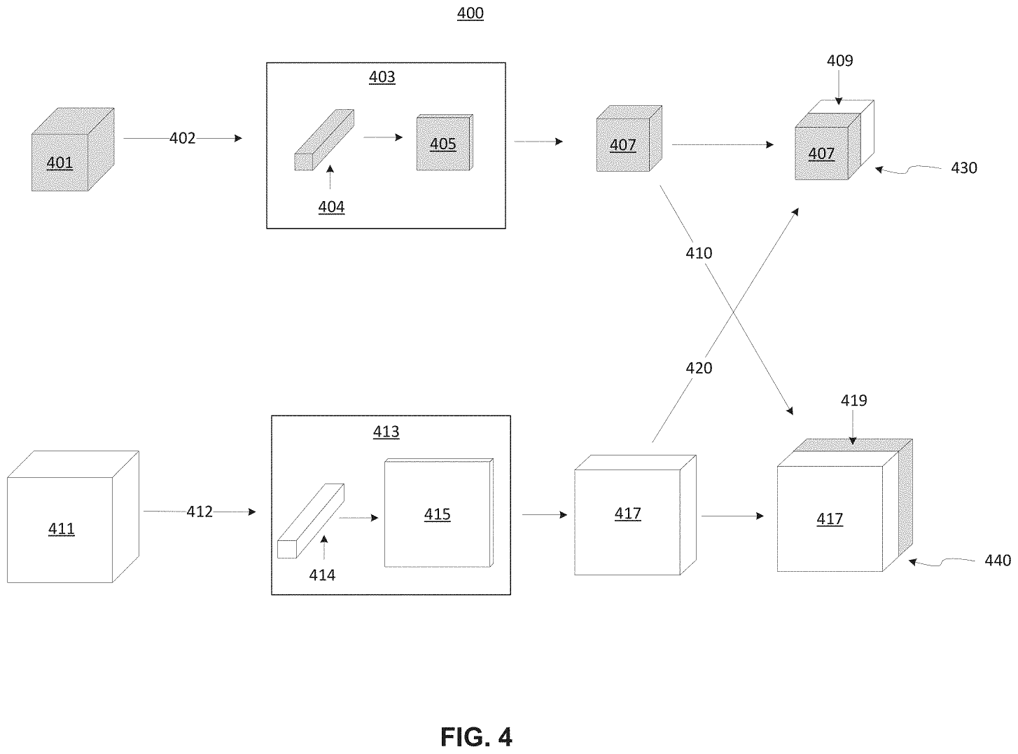

FIG. 4 depicts the exemplary operation of an alternative unconventional convolutional layer 400, consistent with some embodiments of the present disclosure. Convolutional layer 400 can be part of a convolutional neural network configured to generate a convolutional neural network output (e.g., a label, a modified image, a caption, or the like) from a convolutional neural network input (e.g., image data, word embeddings, or the like). Generation of the neural network output can involve processing the convolutional neural network input data through successive processing layers, including convolutional layer 400. Such layers can generate output feature maps using input feature maps. In the example shown in FIG. 4, the input feature map includes a group of high-frequency input channels 411 and a group of low frequency input channels 401. The output feature map can include a group of low-frequency output channels 409 and a group of high-frequency output channels 419. In this exemplary embodiment, by convolving each group of input channels with similarly sized kernels (e.g., kernels 404 and 414) and then combining the outputs, convolutional layer 400 can generate output channels in a single convolution and without requiring the re-sizing and addition of convolution inputs.

Convolutional layer 400 may be implemented using any of a variety of electronic systems. For example, convolutional layer 400 could be implemented using a server, one or more nodes in a datacenter, a desktop computer, a laptop computer, a tablet, a smartphone, a wearable device such as a smartwatch, an embedded device, an IoT device, a smart device, a sensor, an orbital satellite, or any other electronic device capable of computation. Additionally, the implementation of convolutional layer 400 within a given device may vary over time or between instances of convolutional layer 400. For example, in some instances convolutional layer 400 may be implemented using a general processing unit, such as a central processing unit (CPU), a graphics processing unit (GPU), or a general-purpose graphics processing unit (GPGPU). In other embodiments, the artificial neural network may be implemented using a hardware accelerator, such as a neural processing unit (NPU), a field programmable gate array (FPGA), or an application-specific integrated circuit (ASIC).

The input feature map can include groups of channels. Though depicted in FIG. 4 as including two groups of channels (e.g., input group 401 and input group 411), the input feature map can include more than two groups of channels. For example, the input feature map can include between two and thirty-two groups of channels (e.g. 2, 4, 8, 16, or 32 groups of channels), or more than thirty-two groups of channels. Each group of channels can include one or more channels. The depth of a group of channels can be the number of channels in the group. The depth of an input feature map can be the number of channels in the input feature map.

Each input channel can have a size. The size can be the number of feature values in the input channel. For example, an input channel of size 256 can include 256 feature values. In some embodiments, the input channels can be structured as arrays having a height and a width. For example, an input channel of size 256 can have a height of 16 and a width of 16. In some embodiments, each channel in a group of channels can have the same size. Each channel in a group of channels may further have the same width and height.

As depicted in FIG. 4, in step 402, convolutional layer 400 can be configured to convolve input group 401. In some embodiments, this convolution can be performed by a convolutional sub-layer 403. Convolutional sub-layer 403 can be a logical or physical sub-layer. As a non-limiting example of a logical sub-layer, convolutional layer 400 can be configured with data or instructions causing convolutional layer 400 to call a function or service that performs convolution on input group 401. As a non-limiting example of a physical sub-layer, convolutional layer 400 can be implemented using a special purpose architecture configured with hardware accelerators for performing convolution. Convolutional layer 400 can be configured to provide input group 401 to such a hardware accelerator. For example, the physical layer can be a pipeline of a hardware accelerator.

Convolutional sub-layer 403 can be configured to convolve the input group 401 and by one or more kernels to generate one or more output channels. For example, as shown in FIG. 4, convolutional sub-layer 403 can be configured to convolve the input group 401 by kernel 404 to generate output channel 405. In some embodiments, the number of kernels can determine the number of output channels created by convolutional sub-layer 403. The output channels generated by convolutional sub-layer 403 can collectively comprise intermediate feature map 407.

Similarly, in step 412, convolutional layer 400 can be configured to convolve input group 411. In some embodiments, this convolution can be performed by a convolutional sub-layer 413 similar to convolutional sub-layer 403, described above. In some embodiments, convolutional sub-layer 413 and convolutional sub-layer 403 can be the same convolutional sub-layer (e.g., constitute two invocations of the same method, use the same hardware accelerator, use the same pipeline in the same hardware accelerator, or the like).

Convolutional sub-layer 413 can be configured to convolve input group 411 by one or more kernels to generate one or more output channels. For example, as shown in FIG. 4, convolutional sub-layer 413 can be configured to convolve input group 411 by kernel 414 to generate output channel 415. In some embodiments, the number of kernels can determine the number of output channels created by convolutional sub-layer 413. The output channels generated by convolutional sub-layer 413 can collectively comprise intermediate feature map 417.

As depicted in FIG. 4, in step 410 convolutional layer 400 can be configured to resize intermediate feature map 407 to generate resized feature map 419. As shown, resized feature map 419 can have the same size as intermediate feature map 417. For example, resized feature map 419 can have the same width and height as intermediate feature map 417. In some aspects, convolutional layer 400 can be configured to up-sample intermediate feature map 407 to create resized feature map 419. Such up-sampling may be accomplished using deconvolution (e.g., a transposed convolution layer or the like), unpooling, interpolation (e.g., linear interpolation or the like), or another suitable up-sampling method. In some embodiments, resized feature map 419 would then include an up-sampled channel corresponding to each original channel in intermediate feature map 407.

Similarly, as depicted in FIG. 4, in step 420, convolutional layer 400 can be configured to resize intermediate feature map 417 to generate resized feature map 409. As shown, resized feature map 409 can have the same size as intermediate feature map 407. For example, resized feature map 409 can have the same width and height as intermediate feature map 407. In some aspects, convolutional layer 400 can be configured to down-sample intermediate feature map 417 to create resized feature map 409. Such down-sampling may be accomplished using convolution (e.g., convolving each channel in intermediate feature map 417 with a kernel using a stride greater than one, or the like), pooling (max pooling, average pooling, or the like), sampling (e.g., integer or non-integer sampling, or the like), or another suitable down-sampling method. In some embodiments, resized feature map 409 would then include a down-sampled channel corresponding to each original channel in intermediate feature map 417.

Convolutional layer 400 can be configured to combine each intermediate feature map with a resized feature map to generate an output feature map. For example, intermediate feature map 407 can be combined with resized feature map 409 to generate output feature map 430. Similarly, intermediate feature map 417 can be combined with resized feature map 419 to generate output feature map 440. In some embodiments, convolutional layer 400 can be configured to concatenate the intermediate and resized feature maps to generate the output feature maps (e.g., as shown in FIG. 4). In various embodiments, convolutional layer 400 can be configured to perform an element-wise operation to generate each element of the output map from corresponding elements of the intermediate feature map and the resized feature map. As a non-limiting example:

O(i,j,k)=f(I(i,j,k),R(i,j,k))∀i,j,k,

where O(i, j, k) can be the element of output feature map 430 at the i^{th} row, j^{th} column, and k^{th} channel. f(x, y) can be some function of two values (e.g., a sum, product, average, weighted average, output of an activation function taking two values, or the like). I(i, j, k) can be the element of intermediate feature map 407 at the i^{th} row, j^{th} column, and k^{th} channel. R(i, j, k) can be the element of resized feature map 409 at the i^{th} row, j^{th} column, and k^{th} channel. In some instances, convolutional layer 400 can be configured to create or update one or more data structures to store the output feature maps. In some embodiments, a single data structure can include output feature map 430 and output feature map 440. In various embodiments, separate data structures (e.g., in the same memory or separate memories) can store output feature map 430 and output feature map 440. In various embodiments, the one or more data structures can include references to data structures including output feature map 430 and output feature map 440, respectively. In some embodiments, the output feature maps can be provided to an activation function (e.g., identity function, binary step function, logistic function, tanh function, rectified linear unit function, or other activation function) to create the input feature maps for the next layer in the convolutional neural network.

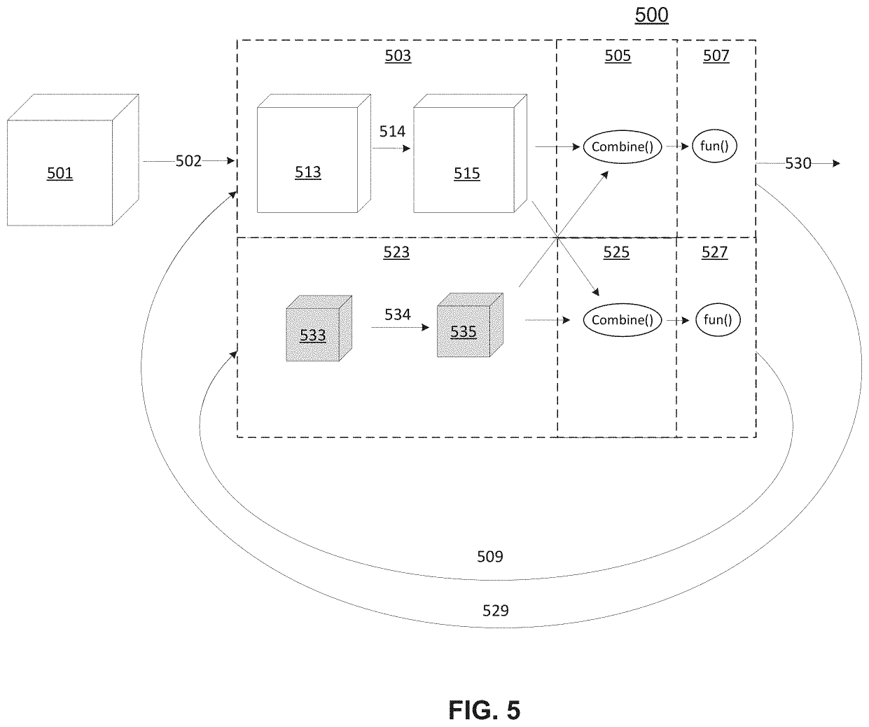

FIG. 5 depicts an exemplary logical diagram of a convolutional neural network (CNN 500) configured to use the unconventional convolutional layer described in FIG. 4. Similar to convolutional layer 400 of FIG. 4, CNN 500 may be implemented using a variety of electronic systems and the implementation of CNN 500 within a given device may vary over time or between instances of CNN 500. In some instances, the convolutional layer may be implemented using a general processing unit, such as a central processing unit (CPU), a graphics processing unit (GPU), or a general-purpose graphics processing unit (GPGPU). In other embodiments, the artificial neural network may be implemented using a hardware accelerator, such as a neural processing unit (NPU), a field programmable gate array (FPGA), or an application-specific integrated circuit (ASIC). For convenience of description and without limitation or prejudice to other implementations, CNN 500 is referred to hereafter as being implemented using a hardware accelerator. As shown in FIG. 5, in some embodiments, CNN 500 can be implemented using two pipelines of the hardware accelerator (e.g., pipeline 503 and pipeline 523). The hardware accelerator can be configured to receive an initial feature map 501 and produce an output feature map 530. The feedback depicted in FIG. 5 (e.g., feedback 509 and feedback 529) can enable this hardware accelerator to be reused to implement multiple convolutional layers in the neural network.

In step 502, CNN 500 can be configured to generate two input feature maps (e.g., including input feature maps 513 and 533) from initial feature map 501. Initial feature map 501 can comprise feature values received from a sensor or another device (e.g., a camera of a device implementing CNN 500, or a remote camera). The feature values can be intensity values for inputs (e.g. the intensity of light impinging on a pixel in a CMOS or CCD array). For example, when CNN 500 receives sensor data from a digital camera, the initial feature map may include three channels, each corresponding to one of the red, green, and blue channels of the digital camera sensor data.

CNN 500 can be configured to generate the input feature map by providing the initial feature map to a sequence of layers. These layers can include a convolutional layer, and may include additional layers (e.g., an embeddings layer, a fully connected layer, or the like). In some embodiments, CNN 500 can be configured to generate multiple input feature maps from initial feature map 501, each of the input feature maps including channels of a different predetermined size. When initial feature map 501 matches a predetermined size of one of the input feature maps (e.g., input feature map 513 or 533), CNN 500 can be configured to use initial feature map 501 as the matching input feature map. For example, when there are three input feature maps of differing sizes and initial feature map 501 matches one of these sizes, CNN 500 can be configured to create two additional input feature maps from the initial feature map 501, each additional input map matching one of the remaining sizes, resulting in an input feature map for each of the predetermined sizes. To continue this example, CNN 500 can be configured to create three additional input feature maps matching each of the predetermined sizes when initial feature map 501 does not match any of the predetermined sizes. CNN 500 can be configured to apply the input feature map to convolutional sub-layers (e.g., through repeated calls to a convolution operation, providing of the input feature map to one or more hardware accelerators, SIMD processors, or the like) to generate intermediate feature maps. Each convolutional sub-layer can be configured to convolve an input feature map with one or more kernels to generate one or more intermediate channels of a corresponding predetermined size.

As a non-limiting example of generating intermediate feature maps from an initial feature map, initial feature map may comprise three channels, each channel including 1024 by 1024 elements. CNN 500 can be configured to generate three input feature maps using the initial feature map: a first input feature map with three channels, each channel in the first group including 2048 by 2048 elements; a second input feature map with three channels, each channel in the second group including 1024 by 1024 elements; and a third input feature map with three channels, each channel in the third group including 512 by 512 elements. CNN 500 can be configured to up-sample the initial feature map to generate the first input feature map, use the initial feature map (or a copy thereof) as the second input feature map, and down-sample the initial feature map to generate the third input feature map. In some embodiments, before being processed as depicted in FIG. 5, each of the input feature maps can be passed through an activation function or one or more other convolutional layers.

As depicted in FIG. 5, a convolutional layer in accordance with disclosed embodiments can be configured to receive one or more input feature maps (e.g., input feature maps 513 and 534 as shown in FIG. 5). The input feature maps can be those created in step 502 or may be the result of further processing of the input feature maps created in step 502 (e.g., processing by additional convolutional layers). Each input feature map can have a predetermined size. For example, as depicted in FIG. 5, the size of input feature group 513 can be larger than the size of input feature group 533. In steps 514 and 534, input feature maps 513 and 533, respectively, can each be convolved with one or more potentially differing kernels to generate intermediate feature maps 515 and 535, respectively. In some embodiments, convolutional sub-layer 503 can be configured to convolve input feature map 513 with one or more kernels, while convolutional sub-layer 523 can be configured to convolve input feature map 533 with one or more potentially differing kernels.

CNN 500 can be configured to combine the intermediate feature maps generated by convolutional sub-layers 503 and 523, as depicted in FIG. 5. Combining the intermediate feature maps can include creating resized versions of the intermediate feature maps. For example, CNN 500 can be configured to create an up-sampled version of intermediate feature map 535 and combine this up-sampled version with intermediate feature map 515 using combination component 505. Similarly, CNN 500 can be configured to create a down-sampled version of intermediate feature map 515 and combine this down-sampled version with intermediate feature map 535 using combination component 525. The creation of a resized version of an intermediate feature map can be performed by a convolutional sub-layer of CNN 500 (e.g., intermediate feature map 515 can be resized by convolutional sub-layers 503) or by a combination component (e.g., intermediate feature map 515 can be resized by combination component 525). As described herein, combining the intermediate feature maps can include concatenating the intermediate feature maps or applying an element-wise function to elements of the intermediate feature maps to generate corresponding elements of an output feature map.

CNN 500 can be configured to apply activation functions to the elements of the output feature maps to generate activation feature maps. The activation functions can convert feature values in the output feature map to activation values. The activation functions can be, or be a function of, an identity function, binary step function, logistic function, tanh function, rectified linear unit function, or other activation function. The activation functions can be the same for each output feature map, or different (e.g., activation function 507 can be the same or differ from activation function 527). In some embodiments, in steps 509 and 529, activation values generated by activation functions 507 and 527 can be used as the inputs to convolutional layers 503 and 523, respectively. In this manner, the outputs generated by convolutional layers 503 and 523 can be repeatedly input to convolutional layers 503 and 523, respectively. Accordingly, convolutional layers 503 and 523 can be configured to provide the functionality of multiple convolutional layers.

In some embodiments, in step 530, CNN 500 can be configured to additionally or alternatively output one or more of the activation feature maps. In some embodiments, CNN 500 can output the activation feature map with the greatest size. In various embodiments, when the activation functions or methods of combining the intermediate feature maps differ, CNN 500 can output a combination of the activation maps generated by activation functions 507 and 527. Generating this combination can include resizing one or more of the activation maps (e.g., by up-sampling or down-sampling one or more activation maps) and concatenating activation maps (e.g., concatenating an activation map with an up-sampled or down-sampled version of another activation map) or applying an element-wise function to elements of the activation maps to generate corresponding elements of an output activation map. The one or more activation feature maps can be output to one or more additional layers of CNN 500, or may comprise the output of CNN 500.

In general, while described with regards to a single convolutional layer, it may be appreciated that one or more additional layers may precede the convolutional layer (e.g., an embedding layer, a fully connected layer, or the like). Similarly, one or more additional layers may follow the convolutional layer (e.g., a fully connected layer, or the like). Furthermore, one or more additional layers or connections (not shown in FIG. 5) may be interposed between iterations of the convolutional layer (e.g., a pooling or unpooling layer, a batch normalization layer, residual neural network (ResNet) connections, or the like).

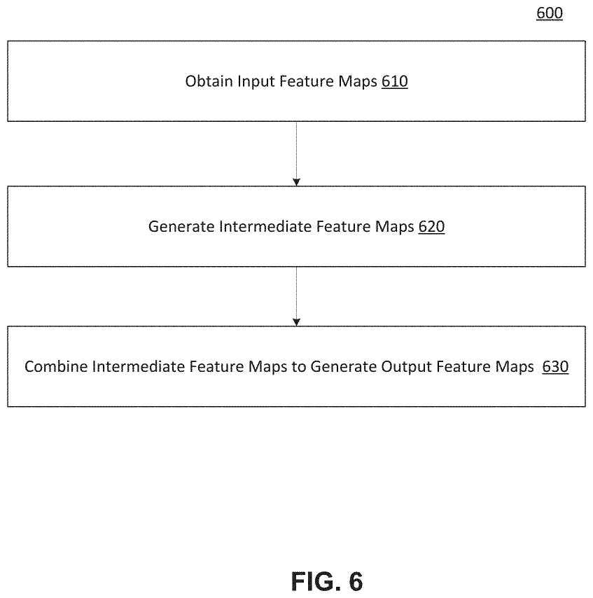

FIG. 6 depicts a method 600 for generating output feature maps from input feature maps of differing sizes, in accordance with some embodiments of the present disclosure. Method 600 can include convolving the input feature maps with respective sets of kernels to generate intermediate feature maps of differing sizes. The intermediate feature maps can be combined to generate output feature maps. Combining the intermediate feature maps can include creating resized versions of the intermediate feature maps. Combining the intermediate feature maps can further include concatenating each intermediate feature map with resized versions of the remaining intermediate feature maps. Additionally or alternatively, for each intermediate feature map, the intermediate feature map and the resized versions of the remaining intermediate feature maps can be input to an element-wise function to generate a corresponding output feature map. Method 600 can be performed by a convolution layer. Similar to convolutional layer 400, the convolutional layer of method 600 may be implemented using any of a variety of electronic systems. Additionally, the implementation of this convolutional layer within a given device may vary over time or between instances of the convolutional layer. For example, in some instances the convolutional layer may be implemented using a general processing unit, such as a central processing unit (CPU), a graphics processing unit (GPU), or a general-purpose graphics processing unit (GPGPU). In other embodiments, the artificial neural network may be implemented using a hardware accelerator, such as a neural processing unit (NPU), a field programmable gate array (FPGA), or an application-specific integrated circuit (ASIC). Accordingly, method 600 can support reduced-size input feature maps, thereby improving the computational efficiency, storage requirements, and precision of a convolutional neural network.

In step 610 of method 600, the convolutional layer can obtain input feature maps. In some instances, the convolutional layer can receive the input feature maps from another convolutional layer, or the output of the convolutional layer can be returned to the input of the convolutional layer. In various instances, the convolutional layer can generate the input feature maps, for example from data received by the convolutional layer. In various instances, the convolutional layer can retrieve the input feature map from a local or remote computer memory accessible to the convolutional layer.

The input feature maps can include one or more channels. The one or more channels in an input feature map can have the same size. For example, they can include the same number of features. As an additional example, the one or more channels in an input feature map may have the same dimensions (e.g., the same width and height). The size of the one or more channels in each input feature map may be predetermined. For example, these sizes may be determined prior to training of the convolutional layer. In this manner, both the number of input feature maps, the number of channels in each input feature map, and the predetermined size of the channels in each input feature map may be hyperparameters associated with the convolutional layer. Such hyperparameters may be optimized during generation and training of the convolutional layer using methods such as a grid search, random search, gradient descent method, Bayesian optimization, or the like. In some embodiments, the input feature layer may include between 2 and 32 groups of channels. In various embodiments, the input feature layer may include 2, 4, 8, 16, or 32 groups of channels.

In some embodiments, the sizes for the channels in the input feature maps may form an increasing sequence, with adjacent sizes in the sequence differing by a factor greater than one. As a non-limiting example, when there are three input feature maps, the first input feature map may include channels with 64 features, the second input feature map may include channels with 256 features, and the third input feature map may include channels with 1024 features. In this example, the adjacent sizes in the sequence differ by a factor of four. In another example, adjacent sizes in the sequence can differ by differing factor (e.g., a first input feature map including channels with 16 features, a second input feature map including channels with 256 features, and a third input feature map including channels with 1024 features).

In some embodiments, a dimension for the channels in the input feature maps may form an increasing sequence, with adjacent dimensions in the sequence differing by a factor greater than one. For example, to continue the prior non-limiting example, the first input feature map may include channels with a width of 8, the second input feature map may include channels with a width of 16, and the third input feature map may include channels with a width of 32. In this example, the adjacent widths differ by a factor of two. In this example, the heights similarly differ by a factor of two. Similar to the sizes, as described above, adjacent dimensions in the sequence can differ by differing factors. Furthermore, in various embodiments, the heights and widths may differ between adjacent dimensions in the sequence by differing factors. For example, the heights may differ by a factor of two between adjacent heights in the sequence, while the widths remain unchanged.

In step 620 of method 600, the convolutional layer can apply the input feature maps to convolutional sub-layers to generate intermediate feature maps. As described above with regards to FIG. 4, such a convolution sub-layer can be a logical or physical sub-layer. Channels of the intermediate feature maps can be generated at the same time or differing times (e.g., each channel of an intermediate feature map can be generated sequentially). In various embodiments, convolution may occur as input feature channels are obtained by the convolutional layer (e.g., input feature map channel D_{X} is applied to a sub-layer to generate an intermediate feature map channel before creation of input feature map channel D_{Y}). The disclosed embodiments are not intended to be limited to a particular order of applying the input feature maps to the convolutional sub-layers, or a particular order of generating the intermediate feature map channels. As would be appreciated by one of skill in the art, the number of intermediate feature map channels can depend on the number of kernels convolved with each input feature map. In some embodiments, a size of the intermediate feature map channels can depend on the dimensions of the input feature map. The size of the intermediate feature map channels can also depend on parameters of the convolution (e.g., stride, padding, and the like).

In step 630 of method 600, the convolutional layer can combine the intermediate feature maps to create output feature maps. The convolutional layer can be configured to create, for each one of the intermediate feature maps, a set of intermediate feature maps including the one of the intermediate feature maps and resized versions of the remaining intermediate feature maps. In some embodiments, the convolutional layer can resize (e.g., by up-sampling or down-sampling) the versions of the remaining intermediate feature maps to match the size of the one of the intermediate feature maps. For example, when the intermediate feature maps A_{X}, B_{Y}, and C_{Z} have sizes X, Y, and Z, respectively, the convolutional layer may be configured to create resized versions A_{Y} and A_{Z} of intermediate feature map A_{X}, resized versions B_{X} and B_{Z} of intermediate feature map B_{Y}, and resized versions C_{X} and C_{Y} of intermediate feature map C_{Z}. In this example, following resizing, there may exist a set of intermediate feature maps A_{X}, B_{X}, and C_{X} of size X; a set of intermediate feature maps A_{Y}, B_{Y}, and C_{Y} of size Y; and a set of intermediate feature maps A_{Z}, B_{Z}, and C_{Z} of size Z. The convolutional layer may combine the intermediate feature maps in each set to form a corresponding output feature map. For example, convolutional layer may combine intermediate feature maps A_{X}, B_{X}, and C_{X} to form output feature map Ox, intermediate feature maps A_{Y}, B_{Y}, and C_{Y} to form output feature map Oy, and intermediate feature maps A_{Z}, B_{Z}, and C_{Z} to form output feature map Oz.

In some embodiments, multiple versions of an intermediate feature map or versions of multiple intermediate feature maps may be created at the same time (e.g., all resizing may occur before any combination). In various embodiments, a version of an intermediate feature map or versions of multiple intermediate feature maps may be created as used by the convolutional layer (e.g., B_{X} and C_{X} are created, then A_{X}, B_{X}, and C_{X} are combined to form Ox before creation of A_{Y} or C_{Y}). The disclosed embodiments are not intended to be limited to a particular order of generating the versions of the groups. As described herein, the resizing can include at least one of convolution, max pooling, averaging pooling, deconvolution, unpooling, or interpolation.

In some embodiments, combining intermediate feature maps can include concatenating channels of the intermediate feature maps. To continue the above example, the convolutional layer can be configured to concatenate A_{X}, B_{X}, and C_{X} to create an output feature map Ox having a depth equal to the sum of the depths of A_{X}, B_{X}, and C_{X} and a height and width equal to the height and width of A_{X}, B_{X}, and C_{X}. Alternatively or additionally, output feature map Ox can be generated by applying an element-wise function to A_{X}, B_{X}, and C_{X}. For example, Ox can be a sum, or weighted sum, of corresponding elements of A_{X}, B_{X}, and C_{X}. The disclosed embodiments are not intended to be limited to a particular order of combining the intermediate feature maps.

In some embodiments, the convolutional layer can be configured to output one or more output feature maps (or one or more activation feature maps). When convolutional layer is configured to output activation feature maps, the convolutional layer can obtain the activation feature maps by applying activation functions to the output feature maps, as described herein. In some embodiments, the convolutional layer can be configured to output the largest output feature map (or largest activation feature map) or a combination of the output feature maps (or a combination of the activation feature maps). When the convolutional layer outputs a combination of the output feature maps (or a combination of the activation feature maps), the combination may be generated as described herein with regards to FIG. 4. The disclosed embodiments are not intended to be limited to a particular method of providing one or more output feature maps (or activation feature maps).

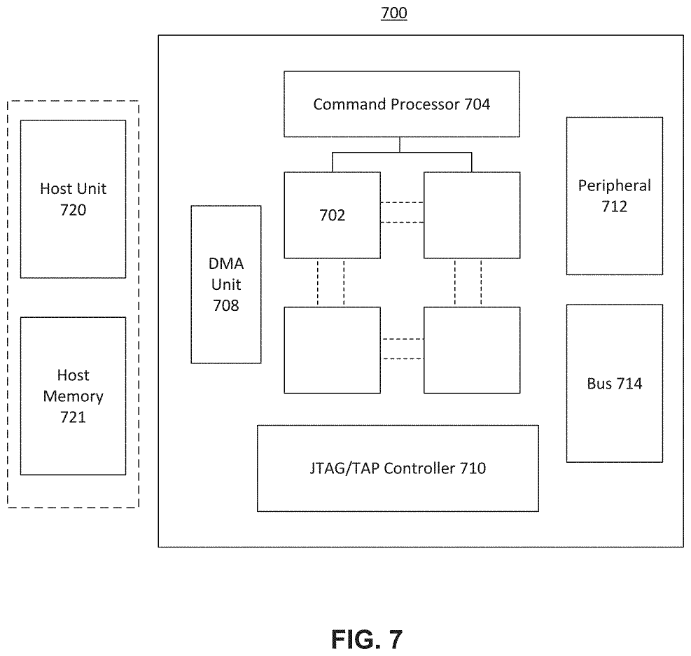

FIG. 7 illustrates an exemplary CNN accelerator architecture 700 suitable for implementing the convolutional layers of FIGS. 1 to 6, consistent with embodiments of the present disclosure. In the context of this disclosure, a CNN accelerator may also be referred to as a machine learning accelerator or deep learning accelerator. In some embodiments, accelerator architecture 700 may be referred to as a neural network processing unit (NPU) architecture 700. As shown in FIG. 7, accelerator architecture 700 can include a plurality of cores 702, a command processor 704, a direct memory access (DMA) unit 708, a Joint Test Action Group (JTAG)/Test Access End (TAP) controller 710, a peripheral interface 712, a bus 714, and the like.

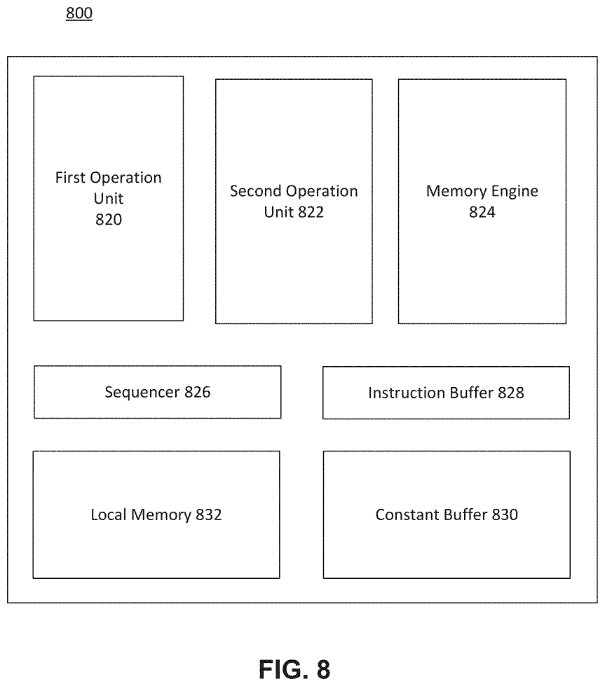

It is appreciated that, cores 702 can perform algorithmic operations based on communicated data. Cores 702 can include one or more processing elements that may include single instruction, multiple data (SIMD) architecture including one or more processing units configured to perform one or more operations (e.g., multiplication, complex multiplication, addition, multiply-accumulate, etc.) based on commands received from command processor 704. To perform the operation on the communicated data packets, cores 702 can include one or more processing elements for processing information in the data packets. Each processing element may comprise any number of processing units. According to some embodiments of the present disclosure, accelerator architecture 700 may include a plurality of cores 702, e.g., four cores. In some embodiments, the plurality of cores 702 can be communicatively coupled with each other. For example, the plurality of cores 702 can be connected with a single directional ring bus, which supports efficient pipelining for large neural network models. The architecture of cores 702 will be explained in detail with respect to FIG. 8.

Command processor 704 can interact with a host unit 720 and pass commands and data to corresponding core 702. In some embodiments, command processor 704 can interact with host unit under the supervision of kernel mode driver (KMD). In some embodiments, command processor 704 can modify the commands to each core 702, so that cores 702 can work in parallel as much as possible. The modified commands can be stored in an instruction buffer. In some embodiments, command processor 704 can be configured to coordinate one or more cores 702 for parallel execution.

DMA unit 708 can assist with transferring data between host memory 721 and accelerator architecture 700. For example, DMA unit 708 can assist with loading data or instructions from host memory 721 into local memory of cores 702. DMA unit 708 can also assist with transferring data between multiple accelerators. DMA unit 708 can allow off-chip devices to access both on-chip and off-chip memory without causing a host CPU interrupt. In addition, DMA unit 708 can assist with transferring data between components of accelerator architecture 700. For example, DMA unit 708 can assist with transferring data between multiple cores 702 or within each core. Thus, DMA unit 708 can also generate memory addresses and initiate memory read or write cycles. DMA unit 708 also can contain several hardware registers that can be written and read by the one or more processors, including a memory address register, a byte-count register, one or more control registers, and other types of registers. These registers can specify some combination of the source, the destination, the direction of the transfer (reading from the input/output (I/O) device or writing to the I/O device), the size of the transfer unit, or the number of bytes to transfer in one burst. It is appreciated that accelerator architecture 700 can include a second DMA unit, which can be used to transfer data between other accelerator architectures to allow multiple accelerator architectures to communicate directly without involving the host CPU.

JTAG/TAP controller 710 can specify a dedicated debug port implementing a serial communications interface (e.g., a JTAG interface) for low-overhead access to the accelerator without requiring direct external access to the system address and data buses. JTAG/TAP controller 710 can also have on-chip test access port interface (e.g., a TAP interface) that implements a protocol to access a set of test registers that present chip logic levels and device capabilities of various parts.

Peripheral interface 712 (such as a PCIe interface), if present, serves as an (and typically the) inter-chip bus, providing communication between the accelerator and other devices (e.g., a host system).

Bus 714 (such as a I²C bus) includes both intra-chip bus and inter-chip buses. The intra-chip bus connects all internal components to one another as called for by the system architecture. While not all components are connected to every other component, all components do have some connection to other components they need to communicate with. The inter-chip bus connects the accelerator with other devices, such as the off-chip memory or peripherals. For example, bus 714 can provide high speed communication across cores and can also connect cores 702 with other units, such as the off-chip memory or peripherals. Typically, if there is a peripheral interface 712 (e.g., the inter-chip bus), bus 714 is solely concerned with intra-chip buses, though in some implementations it could still be concerned with specialized inter-bus communications.

Accelerator architecture 700 can also communicate with a host unit 720. Host unit 720 can be one or more processing unit (e.g., an X86 central processing unit). As shown in FIG. 7, host unit 720 may be associated with host memory 721. In some embodiments, host memory 721 may be an integral memory or an external memory associated with host unit 720. In some embodiments, host memory 721 may comprise a host disk, which is an external memory configured to provide additional memory for host unit 720. Host memory 721 can be a double data rate synchronous dynamic random-access memory (e.g., DDR SDRAM) or the like. Host memory 721 can be configured to store a large amount of data with slower access speed, compared to the on-chip memory integrated within accelerator chip, acting as a higher-level cache. The data stored in host memory 721 may be transferred to accelerator architecture 700 to be used for executing neural network models.

In some embodiments, a host system having host unit 720 and host memory 721 can comprise a compiler (not shown). The compiler is a program or computer software that transforms computer codes written in one programming language into instructions for accelerator architecture 700 to create an executable program. In machine learning applications, a compiler can perform a variety of operations, for example, pre-processing, lexical analysis, parsing, semantic analysis, conversion of input programs to an intermediate representation, initialization of a neural network, code optimization, and code generation, or combinations thereof. For example, the compiler can compile a neural network to generate static parameters, e.g., connections among neurons and weights of the neurons.

In some embodiments, host system including the compiler may push one or more commands to accelerator architecture 700. As discussed above, these commands can be further processed by command processor 704 of accelerator architecture 700, temporarily stored in an instruction buffer of accelerator architecture 700, and distributed to corresponding one or more cores (e.g., cores 702 in FIG. 7) or processing elements. Some of the commands may instruct a DMA unit (e.g., DMA unit 708 of FIG. 7) to load instructions and data from host memory (e.g., host memory 721 of FIG. 7) into accelerator architecture 700. The loaded instructions may then be distributed to each core (e.g., core 702 of FIG. 7) assigned with the corresponding task, and the one or more cores may process these instructions.

It is appreciated that the first few instructions received by the cores 702 may instruct the cores 702 to load/store data from host memory 721 into one or more local memories of the cores (e.g., local memory 832 of FIG. 8). Each core 702 may then initiate the instruction pipeline, which involves fetching the instruction (e.g., via a sequencer) from the instruction buffer, decoding the instruction (e.g., via a DMA unit 708 of FIG. 7), generating local memory addresses (e.g., corresponding to an operand), reading the source data, executing or loading/storing operations, and then writing back results.

According to some embodiments, accelerator architecture 700 can further include a global memory (not shown) having memory blocks (e.g., 4 blocks of 8 GB second generation of high bandwidth memory (HBM2)) to serve as main memory. In some embodiments, the global memory can store instructions and data from host memory 721 via DMA unit 708. The instructions can then be distributed to an instruction buffer of each core assigned with the corresponding task, and the core can process these instructions accordingly.

In some embodiments, accelerator architecture 700 can further include a memory controller (not shown) configured to manage reading and writing of data to and from a specific memory block (e.g., HBM2) within global memory. For example, the memory controller can manage read/write data coming from core of another accelerator (e.g., from DMA unit 708 or a DMA unit corresponding to the another accelerator) or from core 702 (e.g., from a local memory in core 702). It is appreciated that more than one memory controller can be provided in accelerator architecture 700. For example, there can be one memory controller for each memory block (e.g., HBM2) within global memory.

The memory controller can generate memory addresses and initiate memory read or write cycles. The memory controller can contain several hardware registers that can be written and read by the one or more processors. The registers can include a memory address register, a byte-count register, one or more control registers, and other types of registers. These registers can specify some combination of the source, the destination, the direction of the transfer (reading from the input/output (I/O) device or writing to the I/O device), the size of the transfer unit, the number of bytes to transfer in one burst, or other typical features of memory controllers.

While accelerator architecture 700 of FIG. 7 can be used for convolutional neural networks (CNNs) in some embodiments of the present disclosure, it is appreciated that accelerator architecture 700 of FIG. 7 can be utilized in various neural networks, such as deep neural networks (DNNs), recurrent neural networks (RNNs), or the like. In addition, some embodiments can be configured for various processing architectures, such as neural network processing units (NPUs), graphics processing units (GPUs), field programmable gate arrays (FPGAs), tensor processing units (TPUs), application-specific integrated circuits (ASICs), any other types of heterogeneous accelerator processing units (HAPUs), or the like.

FIG. 8 illustrates an exemplary core architecture, consistent with embodiments of the present disclosure. As shown in FIG. 8, core 702 can include one or more operation units such as first and second operation units 820 and 822, a memory engine 824, a sequencer 826, an instruction buffer 828, a constant buffer 830, a local memory 832, or the like.

First operation unit 820 can be configured to perform operations on received data (e.g., feature maps). In some embodiments, first operation unit 820 can include one or more processing units configured to perform one or more operations (e.g., multiplication, complex multiplication, addition, multiply-accumulate, element-wise operation, etc.). In some embodiments, first operation unit 820 can be configured to accelerate execution of convolution operations or matrix multiplication operations.

Second operation unit 822 can be configured to perform resizing operations, as described herein; a region-of-interest (ROI) operations; and the like. In some embodiments, second operation unit 822 can include an resizing unit, a pooling data path, and the like. In some embodiments, second operation unit 822 can be configured to cooperate with first operation unit 820 to resize feature maps, as described herein. The disclosed embodiments are not limited to embodiments in which second operation unit 822 performs resizing: in some embodiments, such resizing can be performed by first operation unit 820.

Memory engine 824 can be configured to perform a data copy within a corresponding core 702 or between two cores. DMA unit 708 can assist with copying data within a corresponding core or between two cores. For example, DMA unit 708 can support memory engine 824 to perform data copy from a local memory (e.g., local memory 832 of FIG. 8) into a corresponding operation unit. Memory engine 824 can also be configured to perform matrix transposition to make a matrix suitable for use in the operation unit.

Sequencer 826 can be coupled with instruction buffer 828 and configured to retrieve commands and distribute the commands to components of core 702. For example, sequencer 826 can distribute convolution commands or multiplication commands to first operation unit 820, distribute pooling commands to second operation unit 822, or distribute data copy commands to memory engine 824. Sequencer 826 can also be configured to monitor execution of a neural network task and parallelize sub-tasks of the neural network task to improve efficiency of the execution. In some embodiments, first operation unit 820, second operation unit 822, and memory engine 824 can run in parallel under control of sequencer 826 according to instructions stored in instruction buffer 828.

Instruction buffer 828 can be configured to store instructions belonging to the corresponding core 702. In some embodiments, instruction buffer 828 is coupled with sequencer 826 and provides instructions to the sequencer 826. In some embodiments, instructions stored in instruction buffer 828 can be transferred or modified by command processor 704.

Constant buffer 830 can be configured to store constant values. In some embodiments, constant values stored in constant buffer 830 can be used by operation units such as first operation unit 820 or second operation unit 822 for batch normalization, quantization, de-quantization, or the like.

Local memory 832 can provide storage space with fast read/write speed. To reduce possible interaction with a global memory, storage space of local memory 832 can be implemented with large capacity. With such capacity, most of data access can be performed within core 702 with reduced latency caused by data access. In some embodiments, to minimize data loading latency and energy consumption, SRAM (static random access memory) integrated on chip can be used as local memory 832. In some embodiments, local memory 832 can have a capacity of 192 MB or above. According to some embodiments of the present disclosure, local memory 832 be evenly distributed on chip to relieve dense wiring and heating issues.

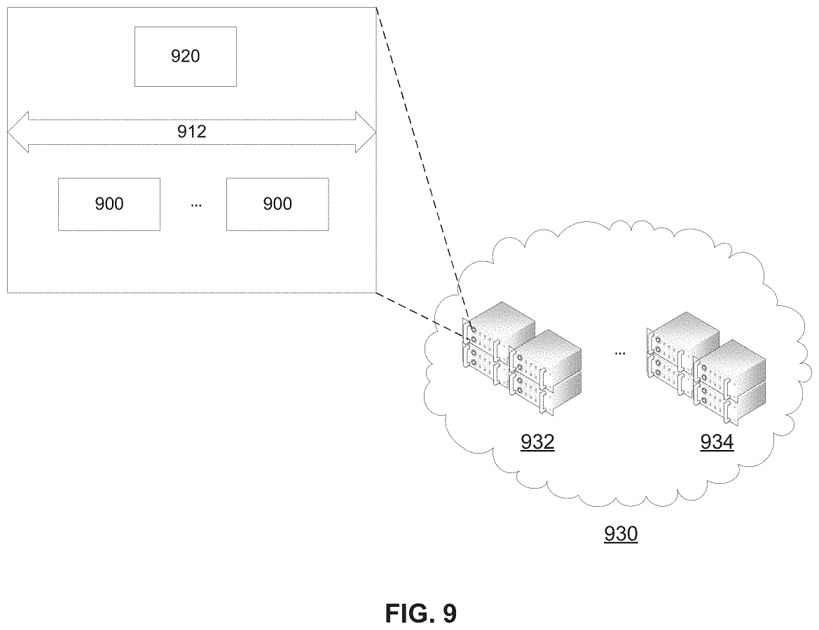

FIG. 9 illustrates a schematic diagram of an exemplary cloud system incorporating accelerator architecture 700, consistent with embodiments of the present disclosure. As shown in FIG. 9, cloud system 930 can provide a cloud service with artificial intelligence (AI) capabilities and can include a plurality of computing servers (e.g., 932 and 934). In some embodiments, a computing server 932 can, for example, incorporate a neural network accelerator architecture 700 of FIG. 7. Neural network accelerator architecture 700 is shown in FIG. 9 in a simplified manner for simplicity and clarity.

With the assistance of neural network accelerator architecture 700, cloud system 930 can provide the extended AI capabilities of image recognition, facial recognition, translations, 3D modeling, and the like. It is appreciated that, neural network accelerator architecture 700 can be deployed to computing devices in other forms. For example, neural network accelerator architecture 700 can also be integrated in a computing device, such as a smart phone, a tablet, and a wearable device.

The embodiments may further be described using the following clauses:

1. A system comprising at least one processor and at least one memory containing instructions that, when executed by the at least one processor, cause the system to perform: generating a neural network output from a neural network input, generation of the neural network output comprising: generating at least two output feature maps using at least two input feature maps, generation of the at least two output feature maps comprising: convolving a first input feature map of the at least two input feature maps with at least one first kernel to generate a first intermediate feature map; convolving a second input feature map of the at least two input feature maps with at least one second kernel to generate a second intermediate feature map; generating, by up-sampling the first intermediate feature map, an up-sampled version of the first intermediate feature map; generating, by down-sampling the second intermediate feature map, a down-sampled version of the second intermediate feature map; combining the first intermediate feature map with the down-sampled version of the second intermediate feature map to generate a first output feature map of the at least two output feature maps; and combining the second intermediate feature map with the up-sampled version of the first intermediate feature map to generate a second output feature map of the at least two output feature maps.

2. The system of clause 1, wherein generation of the neural network output further comprises: obtaining the neural network input; generating, by down-sampling the neural network input, a down-sampled version of the neural network input; and applying the down-sampled version of the neural network input to one or more convolutional neural network layers to generate the first input feature map.

3. The system of any one of clauses 1 or 2, wherein the down-sampling comprises at least one of convolution, sampling, max pooling, or averaging pooling.

4. The system of any one of clauses 1 to 3, wherein generation of the neural network output further comprises combining the at least two output feature maps or selecting one of the at least two output feature maps.

5. The system of any one of clauses 1 to 4, wherein the at least two input feature maps each include channels having a predetermined size, the predetermined sizes differing between the at least two input feature maps.

6. The system of clause 5, wherein the at least two input feature maps comprises 2, 4, 8, 16, or 32 input feature maps.

7. The system of any one of clauses 5 or 6, wherein the predetermined sizes differ by powers of four or more.

8. A system comprising at least one processor; and at least one memory containing instructions that, when executed by the at least one processor, cause the system to perform: generating a neural network output from a neural network input, generation of the neural network output comprising: generating at least two output feature maps of differing channel sizes using at least two input feature maps of the differing channel sizes, generation of the at least two output feature maps comprising: generating a first intermediate map by providing a first input feature map of the at least two input feature maps to a first convolutional sub-layer, the first input feature map having a first channel size; generating a second intermediate map by providing a second input feature map of the at least two input feature maps to a second convolutional sub-layer, the second input feature map having a second channel size; generating, using the first intermediate map, a version of the first intermediate map having the second channel size; generating, using the second intermediate map, a version of the second intermediate map having the first channel size; combining the first intermediate map and the version of the second intermediate map having the first channel size to generate a first output feature map of the at least two output feature maps; and combining the second intermediate map and the version of the first intermediate map having the second channel size to generate a second output feature map of the at least two output feature maps.

9. The system of clause 8, wherein: generating the neural network output comprises repeatedly generating the neural network output; and the at least two input feature maps in a repeat comprise the at least two output feature maps generated in a prior repeat.

10. The system of any one of clauses 8 or 9, wherein: the version of the first intermediate map having the second channel size is generated by up-sampling the first intermediate map; and the version of the second intermediate map having the first channel size is generated by down-sampling the second intermediate map.

11. The system of clause 10, wherein the up-sampling comprises at least one of deconvolution, unpooling, or interpolation.

12. The system of any one of clauses 8 to 11, wherein the differing channel sizes comprise 2, 4, 8, 16, or 32 differing channel sizes.

13. The system of clause 12, wherein the differing channel sizes differ by powers of four or more.

14. A non-transitory computer-readable medium storing a set of instructions that are executable by one or more processors of a system to cause the system to perform: obtaining at least two input feature maps of differing channel sizes; generating an output feature map for each one of the at least two input feature maps, generation comprising: applying the one of the at least two input feature maps to a convolutional sub-layer to generate an intermediate feature map; resizing intermediate feature maps generated from the remaining input feature maps to match the channel size of the each one of the at least two input feature maps; and combining the intermediate feature map and the resized intermediate feature maps to generate the output feature map.

15. The computer-readable medium of clause 14, wherein the at least two input feature maps comprises between 2 and 32 input feature maps.

16. The computer-readable medium of any one of clauses 14 or 15, wherein the differing channel sizes differ by powers of four or more.

17. The computer-readable medium of any one of clauses 14 to 16, wherein the performance further comprises: obtaining an initial feature map; and generating the at least two input feature maps using the initial feature map.

18. The computer-readable medium of any one of clauses 14 to 17, wherein the resizing comprises at least one of convolution, max pooling, averaging pooling, deconvolution, unpooling, or interpolation.

19. The computer-readable medium of any one of clauses 14 to 18, wherein the performance further comprises: generating an output feature map by combining the output feature maps or selecting one of the output feature maps.

20. A method for generating output channels using a convolutional layer of a convolutional neural network, comprising: obtaining at least two input feature maps of differing channel sizes; generating an output feature map for each one of the at least two input feature maps, generation comprising: applying the one of the at least two input feature maps to a convolutional sub-layer to generate an intermediate feature map; resizing intermediate feature maps generated from the remaining input feature maps to match the channel size of the each one of the at least two input feature maps; and combining the intermediate feature map and the resized intermediate feature maps to generate the output feature map.

21. The method of clause 20, wherein the at least two input feature maps comprises between 2 and 32 input feature maps.

22. The method of any one of clauses 20 or 21, wherein the differing channel sizes differ by powers of four or more.

23. The method of any one of clauses 20 to 22, wherein the method further comprises: obtaining an initial feature map; and generating the at least two input feature maps using the initial feature map.

24. The method of any one of clauses 20 to 23, wherein the resizing comprises at least one of convolution, max pooling, averaging pooling, deconvolution, unpooling, or interpolation.

25. The method of any one of clauses 20 to 24, wherein the method further comprises: generating an output feature map by combining the output feature maps or selecting one of the output feature maps.

26. A method for generating at least two output feature maps using at least two input feature maps, using a convolutional layer of a convolutional neural network, the method comprising: convolving a first input feature map of the at least two input maps with at least one first kernel to generate a first intermediate feature map; convolving a second input feature map of the at least two input maps with at least one second kernel to generate a second intermediate feature map; generating, by up-sampling the first intermediate feature map, an up-sampled version of the first intermediate feature map; generating, by down-sampling the second intermediate feature map, a down-sampled version of the second intermediate feature map; combining the first intermediate feature map with the down-sampled version of the second intermediate feature map to generate a first output feature map of the at least two output feature maps; and combining the second intermediate feature map with the up-sampled version of the first intermediate feature map to generate a second output feature map of the at least two output feature maps.

27. The method of clause 26, further comprising: obtaining an input to the convolutional neural network; generating, by down-sampling the input, a down-sampled version of the input; and applying the down-sampled version of the neural network input to one or more convolutional neural network layers to generate the first input feature map.

28. The method of any one of clause 26 or 27, wherein the down-sampling comprises at least one of convolution, sampling, max pooling, or averaging pooling.

29. The method of any one of clauses 26 to 28, wherein generation of an output of the convolutional neural network further comprises combining the at least two output feature maps or selecting one of the at least two output feature maps.

30. The method of any one of clauses 26 to 29, wherein the at least two input feature maps each include channels having a predetermined size, the predetermined sizes differing between the at least two input feature maps.

31. The method of clause 30, wherein the at least two input feature maps comprises 2, 4, 8, 16, or 32 input feature maps.

32. The method of any one of clauses 30 or 31, wherein the at least two input feature maps differ in channel size by powers of four or more.

33. A method for generating at least two output feature maps of differing channel sizes using at least two input feature maps of the differing channel sizes, using a convolutional layer of a convolutional neural network, the method comprising: generating a first intermediate map by providing a first input feature map of the at least two input feature maps to a first convolutional sub-layer, the first input feature map having a first channel size; generating a second intermediate map by providing a second input feature map of the at least two input feature maps to a second convolutional sub-layer, the second input feature map having a second channel size; generating, using the first intermediate map, a version of the first intermediate map having the second channel size; generating, using the second intermediate map, a version of the second intermediate map having the first channel size; combining the first intermediate map and the version of the second intermediate map having the first channel size to generate a first output feature map of the at least two output feature maps; and combining the second intermediate map and the version of the first intermediate map having the second channel size to generate a second output feature map of the at least two output feature maps.

34. The method of clause 33, wherein: generating the neural network output comprises repeatedly generating the neural network output; and the at least two input feature maps in a repeat comprise the at least two output feature maps generated in a prior repeat.

35. The method of any one of clauses 33 or 34, wherein: the version of the first intermediate map having the second channel size is generated by up-sampling the first intermediate map; and the version of the second intermediate map having the first channel size is generated by down-sampling the second intermediate map.

36. The method of clause 35, wherein the up-sampling comprises at least one of deconvolution, unpooling, or interpolation.

37. The method of any one of clauses 33 to 36, wherein the differing channel sizes comprise 2, 4, 8, 16, or 32 differing channel sizes.

38. The method of clause 37, wherein the differing channel sizes differ by powers of four or more.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A system comprising:
at least one processor; and
at least one memory containing instructions that, when executed by the at least one processor, cause the system to perform:
generating a neural network output from a neural network input, generation of the neural network output comprising:
generating at least two output feature maps using at least two input feature maps, generation of the at least two output feature maps comprising:
convolving a first input feature map of the at least two input feature maps with at least one first kernel to generate a first intermediate feature map;
convolving a second input feature map of the at least two input feature maps with at least one second kernel to generate a second intermediate feature map;
generating, by up-sampling the first intermediate feature map, an up-sampled version of the first intermediate feature map;
generating, by down-sampling the second intermediate feature map, a down-sampled version of the second intermediate feature map;
combining the first intermediate feature map with the down-sampled version of the second intermediate feature map to generate a first output feature map of the at least two output feature maps; and
combining the second intermediate feature map with the up-sampled version of the first intermediate feature map to generate a second output feature map of the at least two output feature maps.

2. The system of claim 1, wherein generation of the neural network output further comprises:
obtaining the neural network input;
generating, by down-sampling the neural network input, a down-sampled version of the neural network input; and
applying the down-sampled version of the neural network input to one or more convolutional neural network layers to generate the first input feature map.

3. The system of claim 1, wherein the down-sampling comprises at least one of convolution, sampling, max pooling, or averaging pooling.

4. The system of claim 1, wherein generation of the neural network output further comprises combining the at least two output feature maps or selecting one of the at least two output feature maps.

5. The system of claim 1, wherein the at least two input feature maps each include channels having a predetermined size, the predetermined sizes differing between the at least two input feature maps.

6. The system of claim 5, wherein the at least two input feature maps comprises 2, 4, 8, 16, or 32 input feature maps.

7. The system of claim 5, wherein the predetermined sizes differ by powers of four or more.

8. A system comprising:
at least one processor; and
at least one memory containing instructions that, when executed by the at least one processor, cause the system to perform:
generating a neural network output from a neural network input, generation of the neural network output comprising:
generating at least two output feature maps of differing channel sizes using at least two input feature maps of the differing channel sizes, generation of the at least two output feature maps comprising:
generating a first intermediate map by providing a first input feature map of the at least two input feature maps to a first convolutional sub-layer, the first input feature map having a first channel size;
generating a second intermediate map by providing a second input feature map of the at least two input feature maps to a second convolutional sub-layer, the second input feature map having a second channel size;
generating, using the first intermediate map, a version of the first intermediate map having the second channel size;
generating, using the second intermediate map, a version of the second intermediate map having the first channel size;
combining the first intermediate map and the version of the second intermediate map having the first channel size to generate a first output feature map of the at least two output feature maps; and
combining the second intermediate map and the version of the first intermediate map having the second channel size to generate a second output feature map of the at least two output feature maps.

9. The system of claim 8, wherein:
generating the neural network output comprises repeatedly generating the neural network output; and
the at least two input feature maps in a repeat comprise the at least two output feature maps generated in a prior repeat.

10. The system of claim 8, wherein:
the version of the first intermediate map having the second channel size is generated by up-sampling the first intermediate map; and
the version of the second intermediate map having the first channel size is generated by down-sampling the second intermediate map.

11. The system of claim 10, wherein the up-sampling comprises at least one of deconvolution, unpooling, or interpolation.

12. The system of claim 8, wherein the differing channel sizes comprise 2, 4, 8, 16, or 32 differing channel sizes.

13. The system of claim 12, wherein the differing channel sizes differ by powers of four or more.

14. A non-transitory computer-readable medium storing a set of instructions that are executable by one or more processors of a system to cause the system to perform:
obtaining at least two input feature maps of differing channel sizes;
generating an output feature map for each one of the at least two input feature maps, generation comprising:
applying the one of the at least two input feature maps to a convolutional sub-layer to generate an intermediate feature map;
resizing intermediate feature maps generated from the remaining input feature maps to match the channel size of the each one of the at least two input feature maps; and
combining the intermediate feature map and the resized intermediate feature maps to generate the output feature map.

15. The computer-readable medium of claim 14, wherein the at least two input feature maps comprises between 2 and 32 input feature maps.

16. The computer-readable medium of claim 14, wherein the differing channel sizes differ by powers of four or more.

17. The computer-readable medium of claim 14, wherein the performance further comprises:
obtaining an initial feature map; and
generating the at least two input feature maps using the initial feature map.

18. The computer-readable medium of claim 14, wherein the resizing comprises at least one of convolution, max pooling, averaging pooling, deconvolution, unpooling, or interpolation.

19. The computer-readable medium of claim 14, wherein the performance further comprises:
generating an output feature map by combining the output feature maps or selecting one of the output feature maps.

20. A method for generating output channels using a convolutional layer of a convolutional neural network, comprising:
obtaining at least two input feature maps of differing channel sizes; and
generating an output feature map for each one of the at least two input feature maps, generation comprising:
applying the one of the at least two input feature maps to a convolutional sub-layer to generate an intermediate feature map;
resizing intermediate feature maps generated from the remaining input feature maps to match the channel size of the each one of the at least two input feature maps; and
combining the intermediate feature map and the resized intermediate feature maps to generate the output feature map.

21. The method of claim 20, wherein the at least two input feature maps comprises between 2 and 32 input feature maps.

22. The method of claim 20, wherein the differing channel sizes differ by powers of four or more.

23. The method of claim 20, wherein the method further comprises:
obtaining an initial feature map; and
generating the at least two input feature maps using the initial feature map.

24. The method of claim 20, wherein the resizing comprises at least one of convolution, max pooling, averaging pooling, deconvolution, unpooling, or interpolation.

25. The method of claim 20, wherein the method further comprises:
generating an output feature map by combining the output feature maps or selecting one of the output feature maps.
